(19) United States
(12) Patent Application Publication
(10) Pub. No.: US 2013/0166417 A1
(43) Pub. Date: Jun. 27, 2013

(54) Company Store

(71) Applicants: Sebastian Pulkowski, Eggenstein (DE); Markus Schmidt-Karaca, Heidelberg (DE)

(72) Inventors: Sebastian Pulkowski, Eggenstein (DE); Markus Schmidt-Karaca, Heidelberg (DE)

(21) Appl. No.: 13/334,046

(22) Filed: Dec. 21, 2011

(51) Int. Cl. G06Q 30/00

(52) U.S. Cl. 705/27.1

(57) ABSTRACT

System, method, and computer program product for providing a company store are disclosed. Providing of the company store includes providing a first listing of a plurality of first solutions, wherein at least one solution in the plurality of first solutions is configured to be downloaded and installed by a user to at least one device associated with the user, conducting, by the user using the at least one device, based on at least one user requirement, a search for the at least one solution in the plurality of first solutions, generating, based on conducting, a second listing of the plurality of first solutions, selecting, by the user using the at least one device, at least one solution in the second listing of the plurality of first solutions, and downloading and installing, by the user using the at least one device, the selected at least one solution on the at least one device. At least one of the providing, the conducting, the generating, the selecting and the downloading and installing can be performed on at least one processor.

### TECHNICAL FIELD

This disclosure relates generally to data processing and, in particular, to providing a store for making mobile solutions available to users.

### BACKGROUND

Businesses rely on business enterprise resource planning (“ERP”) systems, solutions, programs, and other software to assist them in performing various tasks as well as allowing them to run smoothly. The day-to-day operations may include a multitude of tasks such as purchasing, selling, distribution, payroll, accounting, benefits, security, maintenance, and various other tasks that businesses need to stay afloat in a dynamic marketplace. The ERP systems, solutions, and other software that may perform these tasks may come from different vendors and/or designed using different computing platforms (e.g., programming languages, operating environments, etc.). As the technology advances and business strive to be more efficient, expedient, and more economical in performing their tasks, they may require instantaneous access to a multitude of business solutions/applications as well as updates to their current application portfolio. This can keep businesses competitive and attractive to their customers.

In the past, businesses were forced to separately purchase requisite business solutions/applications, ERP systems, operating systems, programs, and/or other software from a multitude of vendors. Even businesses' customers desiring to obtain certain services from businesses may have been forced to venture out either at the direction of the businesses or on their own to obtain a desired business solution/application. Also, customers seeking to use a particular business solution/application of a business were forced to obtain that solution/application by way of a separate purchase, which would be delivered by the business to the customer in the form of a CD-ROM, DVD-ROM, or any other media. The customers had no way of determining whether further solutions/applications would be required in addition to the one already purchased. This is because businesses lacked a unified marketplace where their customers could browse catalogs of business solutions/applications offered by the businesses, select a particular solution/application from the catalogs, determine whether the selected solution/application can operate on customers' operating systems and environments, determine whether any additional solutions/applications need to be purchased, and purchase such solution(s)/application(s).

Thus, there is a need to provide a single marketplace or a “store” (e.g., a virtual store) for use by customers that can be accessed with customers' mobile device as well as other computing devices and/or systems for the purposes of obtaining various business solutions/applications. Such stores can also be used to obtain third-party business solutions/applications, upload business solutions/applications, and/or performing any other tasks.

### SUMMARY

In some implementations, the current subject matter relates to a computer-implemented method. The method can include providing a first listing of a plurality of first solutions, wherein at least one solution in the plurality of first solutions is configured to be downloaded and installed by a user to at least one device associated with the user, conducting, by the user using the at least one device, based on at least one user requirement, a search for the at least one solution in the plurality of first solutions, generating, based on conducting, a second listing of the plurality of first solutions, selecting, by the user using the at least one device, at least one solution in the second listing of the plurality of first solutions, and downloading and installing, by the user using the at least one device, the selected at least one solution on the at least one device. At least one of the providing, the conducting, the generating, the selecting and the downloading and installing can be performed on at least one processor.

In some implementations, the current subject matter can be configured to include one or more of the following optional features. At least one device can be a mobile device.

The method can also include generating a third listing of a plurality of solutions, wherein the third listing is configured to include at least one solution in the plurality of first solutions, and associating the generated third listing with a first customer. Further, the method can include accessing, by the user using the at least one device, the generated third listing associated with the first customer, conducting, by the user using the at least one device, based on at least one user requirement, a search for the at least one solution in the third listing of the plurality of solutions, selecting, by the user using the at least one device, at least one solution from the third listing of the plurality of solutions, and downloading and installing, by the user using the at least one device, the at least one solution selected from the third listing of the plurality of solutions on the at least one device.

In some implementations, at least one user requirement can be configured to include at least one of the following: an identification of user, an identification of solutions that the user is configured to use on the at least one device associated with the user, an identification of the at least one device associated with the user, a number of users configured to use the selected at least one solution after the selected at least one solution is downloaded and installed, and a number of devices associated with the user configured to use the selected at least one solution after the selected at least one solution is downloaded and installed.

In some implementations, downloading and installing can include requesting payment from the user for the selected at least one solution.

In some implementations, the selected at least one solution can be configured to correspond to a trial version of the selected at least one solution, wherein the trial version can be configured to limit use of the selected at least one solution by the user after the downloading and installing. The method can also include testing, by the user using the at least one device, the trial version of the selected at least one solution, and determining, by the user using the at least one device, whether to purchase a full version of the selected at least one solution, wherein the full version of the selected at least one solution does not limit use of the selected at least one solution by the user after the downloading and installing.

Articles are also described that comprise a tangibly embodied machine-readable medium embodying instructions that, when performed, cause one or more machines (e.g., computers, etc.) to result in operations described herein. Similarly, computer systems are also described that can include a processor and a memory coupled to the processor. The memory can include one or more programs that cause the processor to perform one or more of the operations described herein.

The details of one or more variations of the subject matter described herein are set forth in the accompanying drawings and the description below. Other features and advantages of the subject matter described herein will be apparent from the description and drawings, and from the claims.

Articles are also described that comprise a tangibly embodied machine-readable medium embodying instructions that, when performed, cause one or more machines (e.g., computers, etc.) to result in operations described herein. Similarly, computer systems are also described that can include a processor and a memory coupled to the processor. The memory can include one or more programs that cause the processor to perform one or more of the operations described herein.

The details of one or more variations of the subject matter described herein are set forth in the accompanying drawings and the description below. Other features and advantages of the subject matter described herein will be apparent from the description and drawings, and from the claims.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 illustrates an exemplary store front infrastructure, according to some implementations of the current subject matter;

FIG. 2 illustrates an exemplary mobile solution process flow, according to some implementations of the current subject matter;

FIG. 3 illustrates an exemplary company store system, according to some implementations of the current subject matter;

FIGS. 4a-c illustrate exemplary lifecycle management scenarios relating to a solution/application, according to some implementations of the current subject matter;

FIG. 5 illustrates an exemplary process for allowing an end user to access a company store and search for various business solutions/application, according to some implementations of the current subject matter;

FIG. 6 illustrates an exemplary process for obtaining a trial version of a solution/application for the user's device, according to some implementations of the current subject matter;

FIG. 7 illustrates an exemplary process for purchasing a solution/application, according to some implementations of the current subject matter;

FIG. 8 illustrates an exemplary process for setting up a customer's store, according to some implementations of the current subject matter;

FIG. 9 illustrates an exemplary process for operating a customer store, according to some implementations of the current subject matter;

FIG. 10 illustrates an exemplary process, according to some implementations of the current subject matter; and

FIG. 11 illustrates an exemplary system, according to some implementations of the current subject matter.

### DETAILED DESCRIPTION

To address these and potentially other deficiencies of currently available solutions, one or more implementations of the current subject matter provide methods, systems, articles or manufacture, and the like that can, among other possible advantages, provide systems and methods for providing systems, methods, and computer program products for providing a unified marketplace or a “store” (e.g., a virtual store) for customers and businesses to access and obtain various enterprise resource planning (“ERP”) systems, operating systems, software, programs, and/or various business solutions (hereinafter, “solutions” or “business solutions”).

Businesses as well as individual users use various mobile devices to conduct a substantial portion of their activities. Such activities typically include sales, purchasing, accounting, reporting, data transferring, transfer of funds, and many others. The activities are typically performed using various software that can be downloaded and installed on mobile devices. The software can be available from various vendors, which can include businesses themselves as well as third party vendors that may be providing desired functionalities to businesses. Businesses can also sell their software, business solutions, applications, programs, etc. for mobile device via mobile application software “store fronts” (e.g., that can be available on the internet), third party vendors (e.g., iTunes that is available through Apple, Inc. Cupertino, Calif., USA), and/or have such business solutions pre-installed on users' mobile devices. Alternatively, businesses can also provide such business solutions to others free of charge or on some other basis. The mobile devices can include cellular telephones, portable computers, laptops, smartphones, Blackberry devices, iPhone, iPad, iPod, personal digital assistants (PDAs), Palm Pilots, and/or any other suitable devices.

To obtain a particular business solutions from a business, a user can access that business's business solution mobile store front and select a particular business solution from a listing of solutions available on that business' store front. Alternatively, the user can search for a specific business solution on the internet utilizing a browser function on the user's mobile device without directly accessing a store front. As stated above, the user's mobile device can also be pre-installed with either the desired business solution(s) and/or have a store front of that particular business pre-installed, which the user can use to obtain a desired business solution.

The user can purchase the solutions while acting in different capacities, including an enterprise user purchasing business solution(s) for a company, an end user purchasing business solution(s) for his/her company mobile device, an end user purchasing business solution(s) via a Web browser, and/or the user acting in any other capacity. While acting in one or several different capacities, the user can be charged with obtaining and/or purchasing various business solutions for installation on the user's mobile device, on business's mobile devices, on business's other devices, on devices of specific users of the business, as well as for any other purposes. The user can be also charged with obtaining quotations for purchasing of particular business solutions and for providing them to the business prior to receiving authorization to purchase.

The store fronts (such as the SAP Store of SAP AG, Waldorf, Germany) can include a listing of various business solutions in a form of a catalog, which the user can browse in order to select a particular business solution. The user can also filter the catalog in search for a particular business solution using one or more attributes. The attributes can include, but are not limited to, business solution's or application's operation system (“OS”) type/OS operating versions, solution type, industries, business area, language of the application, most popular applications, rating of applications, newly available applications, cost, topics (e.g., “Analytics”, “Sales”, etc.), capacity of the user, etc. The filtering can also include classification of the applications according to at least one the following activities: application OS type: (e.g., Blackberry, Apple, etc.), OS version (e.g., Apple iOS 4.3), solution type (e.g., mobile application), language of the application, application family (e.g., combination of multiple applications into a single product but with different OS/device types), application's release status (e.g., released, in beta mode, etc.), application's store visibility (e.g., a complete SAP Store, a company store, etc.), application's location (e.g., local download from store/backend, third party store, such as, for example, an Apple application store, that is send to customer via partner), application cost range (e.g., free, $0.01-10, more than $10, etc.), application type (e.g., native application connected directly to backend, player application which can require backend user, web application, etc.), latest version of the application, a specific version of the application, requirement of installation of the application and other components/systems (e.g., installation of application only, backend components necessary, user license necessary, etc.). The user shall start a search on the catalog to narrow down the results.

To locate a particular application, the user can initiate a search at the store front using various keywords, categories, features, attributes, filters, etc. After the search, a list of possible applications can be presented to the user, which can reflect the search/filtering. For each application in the list, the following information can be presented (or otherwise be requested through various menus and requests): name of the application, short description of the application, rating of the application (with possibility to drill down to a single evaluation), for which mobile device the application exists, pricing information, symbol for video/demo drill down, symbol for screenshot, symbol for drill down to technical information/requirements of the application, a details button (e.g., hyperlinks linking the user to additional detail information), number of available downloads for a particular application, an option for evaluation after registration and download, an option to directly buy the application, as well as any other desired information about each application in the list.

The store front can also include various features that can assist the user in the search, selection, and/or purchasing/obtaining of a specific application. Such features can include, but are not limited to, information about device recognition (including recognition of underlying OS version), information about a process for employees to upload content into the store front, discussion of content, internal catalog information that can only be visible by employees of a company, a portion of the store front and/or entire store front that can be especially dedicated to obtaining mobile content (e.g., by searching for applications using product and/or device), selection criteria information in the catalog, download area information (e.g., external and/or internal), internal and/or external download possibilities, as well as any other features that can assist the user in obtaining business solutions using user's mobile device.

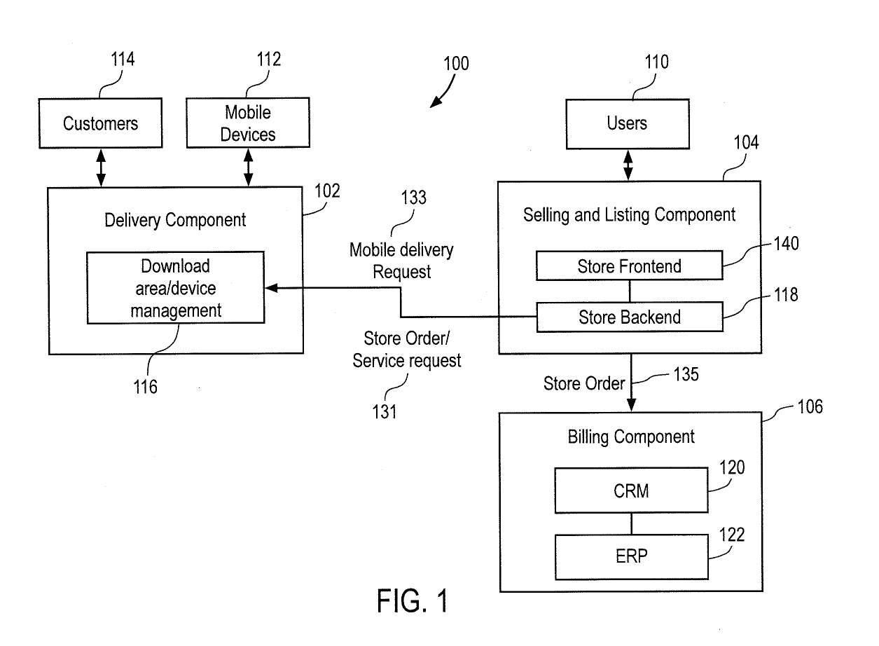

In some implementations, the store front can be configured to operate based on various principles, which can include selling and listing, billing, and delivery of business solutions/applications. FIG. 1 illustrates an exemplary architecture 100 of an infrastructure that can be configured to implement these principles (such exemplary architecture is available from SAP AG, Waldorf, Germany). The architecture 100 includes a delivery component 102, a selling and listing component 104, and a billing component 106. The selling and listing component 104 can be configured to provide a catalog of business solutions/applications, where the catalog can be configured to provide a description of the business solutions/applications in a way that it can become attractive to the user. The user can select a business solution/application from the catalog and upon selection, can complete a sales order for the selected solution/application. The infrastructure can be configured to identify the sold solution/application outside the store front in order to get a match between what had been sold and what will be delivered to the user. In some implementations, the sellable units can include software, installation, and/or provisioning of on-demand software and/or services. Users 110 can access the selling and listing component via the store frontend 140, which can present the users 110 with a catalog of available business solutions/applications and allow the users 110 to browse/search for a desired business solution/application. The selling and listing component 104 can also include a store backend 118 coupled to the store frontend 118, which can receive selection of business solutions/applications by users 110 and can forward a delivery request 133 to the delivery component 102 as well as a store order 135 to the billing component 106.

In some implementations, the selling and listing component 104 can include a user interface that can allow the user to browse/search, select, obtain, and/or purchase a particular business solution/application. The user interface can be configured to have a specialized look and feel, a separate entry point just for a mobile device, and/or a special layout when displaying mobile catalog items as there can be different parameters to be displayed. In some implementations, the user interface can also provide a link that the user can select for immediate download/installation of the selected/purchased business solution/application. It can also allow the user to download/install the selected/purchased business solution/application at a predetermined time. The user interface can also provide various other options that can accommodate the user during user's selection/purchasing experience of the business solution/application.

The billing component 106 can include a customer relationship management (“CRM”) system 120 and an enterprise resource planning (“ERP”) system 122. The billing component can be configured to handle various aspects of billing and payment for the business solutions/applications selected by the user 110 at the selling and listing component 104. Exemplary CRM and ERP systems 120, 122 can be available from SAP AG, Waldorf, Germany, and can handle billing, payment, reporting, storage, customer service, etc. that are associated with purchasing.

The delivery component 102 can be configured to handle store order/service requests 131 and/or mobile delivery requests 133 that are received from the selling and listing component 104. Such requests are associated with the business solutions/application that is selected by the user 110 at the selling and listing component 104. The component 102 can include a download/device management area/service provider 116 that can handle such requests and provide purchased business solutions/applications to customers 114 and/or mobile devices 112.

In some implementations, the delivery component 102 can be configured to operate based on various components and/or requirements that can be associated with delivery of selected/purchased business solution/application to customers. These can include a repository for installer files for various supported platforms, a directory of available applications, an ability to download an installer application that can allow installation of the selected/purchased business solution/application, a device recognition to indentify the right version of selected/purchased business solution/application, various accessibility options available from the device, license management that can allow verification of whether the download is approved and the individual who is downloading the selected/purchased business solution/application is authorized to do so, a device management capability that can perform a push of the selected/purchased business solution/application to various devices, a contingent handling capability that can perform a countdown of downloads based on a license contingent, a user management capability that can identify a user and its relationship to the purchasing organization, an authentication capability that can allow access to selected/purchased business solution/application by users having proper permissions (which can be based on prior purchases), an integration with software logistics processes (which can include development of applications, versioning, release dependency, dependency to backend releases), a legal requirement, a verification capability that can ensure that only verified applications are uploaded, an integration capability that allows integration with customers device management tools, an on-site download at customer infrastructure capability, a capability of transferring of purchased installers to customer site for internal distribution, a bandwidth optimization capability, various support capabilities, scalability and load balancing capabilities, streaming capabilities, mechanisms to cover unstable connectivity, and/or other capabilities, and/or any combination thereof.

In some implementations, the delivery request message 133 can be configured to include a name and identification of the selected business solution/application, a number of licenses (e.g., a number of users/devices that can be authorized to download, install and/or use the application), and/or various authentication details.

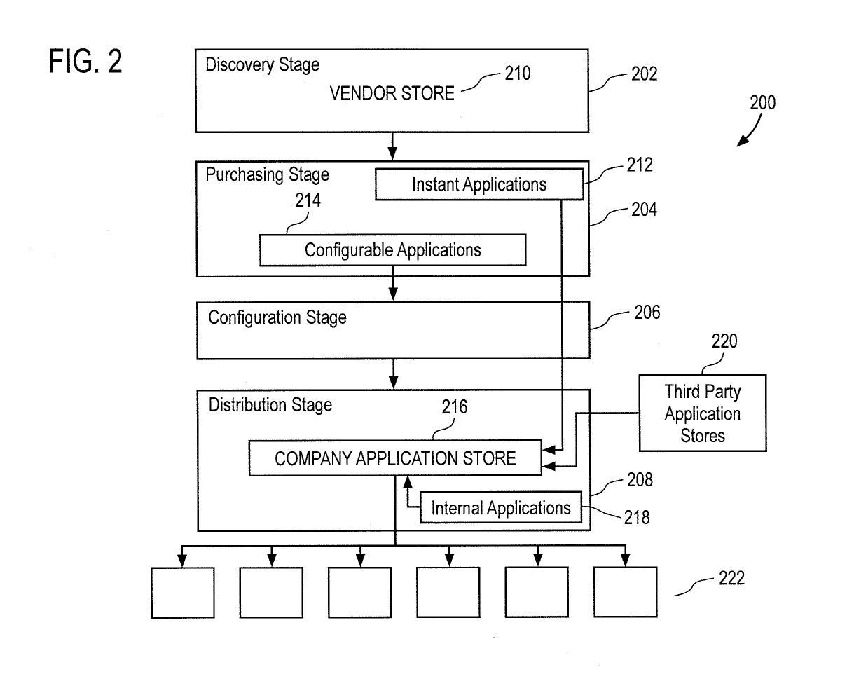

FIG. 2 illustrates an exemplary system process flow 200 for a mobile solution that can be utilized by a user for searching, selecting, obtaining a particular business solution/application as well as checking its compatibility with user's systems, according to some implementations of the current subject matter. At 202, the user can be configured to access a vendor store 210 to conduct a discovery or search for a particular business solution/application. Alternatively, the user can browse all business solutions/applications that may be available from the vendor. The vendor can have different types of business solutions/applications that can be made available to the user, which can include instant applications 212 (i.e., those that the user can install in an as-is format without any configuration) and configurable applications 214 (i.e., those that the user can customize to fit the user's needs). While searching for a particular business solutions/application, the user can also determine whether or not vendor's applications are compatible with the user's system. This can be done by requesting appropriate information about vendor's application or providing appropriate search keywords corresponding to the compatibility requirements of the user's system.

In some implementations, an instant application can be a lightweight solution which can include only the application that is installed on the device and can be connected to the backend and used instantly. This type of application can be purchased by the company purchaser or end user purchasing a license on behalf of the company (e.g., purchasing for a company device).

In some implementations, a more complex scenario can involve installation of various additional components like Gateways, ERP add-ons, backend components, etc. The purchase process can be complicated in view of possible license negotiations, discounts etc. that have to be taken in to consideration. This can lead to an analysis of the existing system environment and can eventually lead to a request for quote from the customer concerning pricing of a particular business solution/application. A compatibility check determines whether or not a particular selected business solution/application will work in the user's system, requires add-ons, other software, etc.

If instant applications 212 are selected by the user, the process proceeds to distribution, at 208, where the selected application is provided to the user's company application store 216 and eventually to mobile devices 222 that are associated with the user's company. A compatibility check can be performed at that stage as well to determine whether the selected instant application 212 is compatible with the user's system. In configurable applications 214 are selected, the applications can be configured, at 206, prior to being provided to the company application store 216. At that time, the configured application can be checked for compatibility with the user's system. Other applications, such as third party applications 220 and internal applications 218, can also be provided to the company application store for eventual distribution to mobile devices 222. Compatibility of these applications is checked as well prior to distribution of the applications to mobile devices or other components or systems/sub-systems of user's system.

Thus, the current subject matter can be configured to provide a seamless buying experience for the user from initial discovery of a business solution/application at 202 to trying on the business solution/application on a mobile device up to ordering the business solution/application through the commercial platform. At various stages of this process, compatibility checks can be performed to determine whether or not the selected business solution/application is compatible with the user's system and/or various mobile devices associated with the user's system.

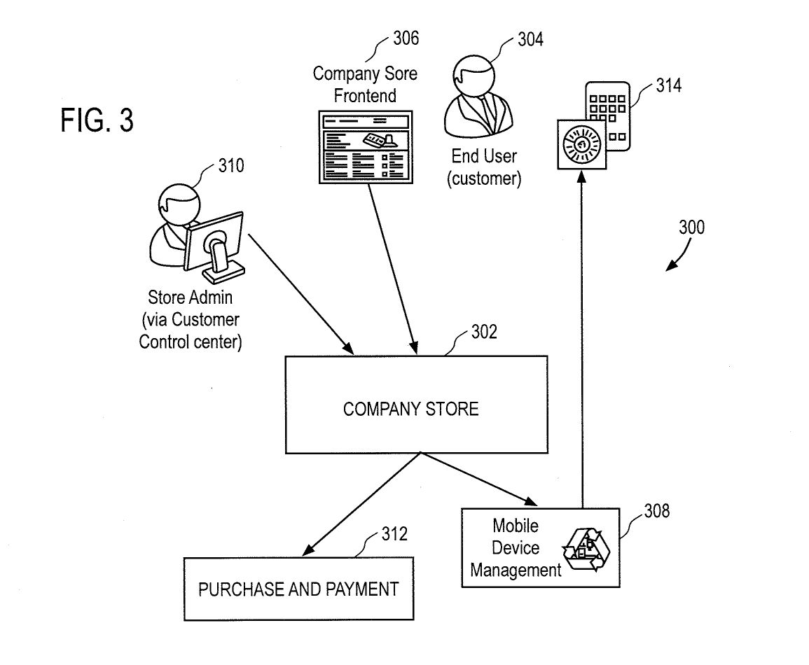

In some implementations, the current subject matter can be configured to relate to a company store system 300 shown in FIG. 3. A company store 300 can be available via the internet and a user can be configured to access the company store 300 using user's mobile device, a stationary computing device, and/or in any other fashion. The company store 300 can be configured to include a user interface that can be displayed on a monitor or on a screen of the user's mobile device. The company store 300 can be configured to offer a catalog of various business solutions/applications. The user can browse/search the catalog to locate a desired business solution/application, which can be used on the user's personal mobile device, company's device, mobile devices of other users associated with the company, and/or on any devices of parties that desire to obtain the business solutions/applications from the company store. In some implementations, a company and/or an individual user can be configured to upload and/or otherwise push business solutions/applications and/or any other content to the company store whether or not such solutions/applications/content is eventually destined for use by any user.

In some implementations, the company store can restrict access to employees of the company, specific or all employees of a particular customer of the company, a particular user, and/or make the store publicly accessible. The company store can also have publicly accessible areas and/or areas with restricted access. The store can be configured to allow purchasing of solutions and licenses for company-specific products as well as company's partner products. In some implementations, a company catalog of business solutions/applications and/or a company's partner's catalog can be added for browsing and/or distribution. As stated above, the store can be configured to add company-developed business solutions/applications to the company catalog, and hence, make them available to users/customers. Such company-developed solutions/applications can be pushed into the store as soon as they are available and/or have completed all necessary testing. This way, company's customers can have latest updates to their business solutions/applications available to them instantaneously. In some implementations, company's partners and/or company-approved individual users can be configured to add their own developed business solutions/applications to the company's catalog. Further, the company's end user can also purchase, install, and/or otherwise obtain a license to use a specific business solution/application from the company catalog.

In some implementations, the catalog can be configured to be customized for a particular company's customer. The company's customer can indicate that the customer is interested only in particular group of business solutions/applications offered by the company, can further manage the customized catalog according to customer's needs (e.g., add or delete solutions/applications, change customer's preferences, negotiate additional licenses, request changes in billing practices, and/or any other customization options). The customer can also perform various other customization functions, such as, perform user administration and device management (e.g., addition/deletion of authorized users, devices, etc.), purchase additional licenses for the existing and/or new business solutions/applications, as well as workflow handling.

Referring back to FIG. 3, the system 300 includes a company store 302 that can be configured to include a catalog of business solutions/applications available from the company, including customer individual catalogs along with customer roles that can be assigned to particular customer's users, customer developed applications, company developed applications, third party developed applications, as well as any other content. The customer 304 and/or its clients can be configured to access company store 302 using company store's frontend 306 in order to browse a catalog of available business solutions/applications. The frontend 306 can be configured to include a user interface that can assist in browsing the catalog. The catalog can be the entire company's catalog of solutions/application or it can be customized for a particular customer. The customer can also be provided with a customer control center or an store administrator 310 that can be configured to perform various catalog management and administrative functions, including addition/deletion of solutions/applications to/from the catalog, addition/deletion of authorized users and/or devices, licensing negotiations, purchasing, payment and billing, as well as any other functions. Once the customer and/or its clients has selected a particular solution/application from the catalog, the customer/client can be configured to purchase the selected solutions/application and pay for a specific number of licenses that may be needed to install and use the application on any of its devices. A mobile device management component 308 of the system 300 can be configured to provide management of mobile devices 314 of the customer/client by supplying the customer's/client's mobile devices with the selected solutions/applications and managing, overseeing installation, licensing, compatibility, device recognition, and usage of the solutions/applications, as well as any other functions. In some implementations, the customer's catalog appearing in the company store can be branded with customer's logo information. In some implementations, the customer's catalog can be available to the customer/client (and/or to any other designated third party) on demand by accessing the company store or it can be available by accessing the customer directly, where the customer's catalog can be hosted by the company store.

In some implementations, the system 300 can be configured to be used in various scenarios, some of which are discussed below. In one scenario, a customer's employee can search the customer's or a company's catalog, select a particular solution/application, and then install the selected solution/application on the employee's (or other employees') mobile devices. The solution/application can be from the customer's catalog and/or from the overall company store catalog, where the solution/application can be developed by the company and/or its partner and/or the customer itself. The customer can also perform customer's user management via a customer's control center. This can be accomplished through maintaining customer's user roles and profiles, customer's users (e.g., by adding, deleting, updating customer's users, etc.) and/or user devices (e.g., adding new devices, updating user profiles, deleting devices, modifying preferences, etc.). In another scenario, an external third party can request to obtain a mobile solution/application. The third party can be configured to access customer's catalog or alternatively, a company catalog depending on the desired solution/application, where the solution/application can be developed by the company and/or its partner and/or the customer itself Further, the system 300 can be configured to allow management of external users (whether or not such users are customer's clients or any other users) by adding or deleting them, modifying their preferences and/or authorization privileges, adding and/or deleting their mobile devices, as well as performing any other functions.

In some implementations, the system 300 can also be configured to perform customer catalog management by adding/deleting external solutions/applications to customer's catalog (e.g., by buying solutions/applications and/or appropriate licenses from the company store), adding customer-internal solutions to the customer catalog, buying additional licenses of a solution/application, as well as performing any other catalog management functions. The company store can be configured to display customer's browsing and activities log in association with customer's catalog and/or any individual customer's solutions/applications. In some implementations, the customer can be configured to have its own store front within the company store, whereby customer's users or clients can access the customer's store front directly and browse/search customer's solutions/applications without accessing the company store.

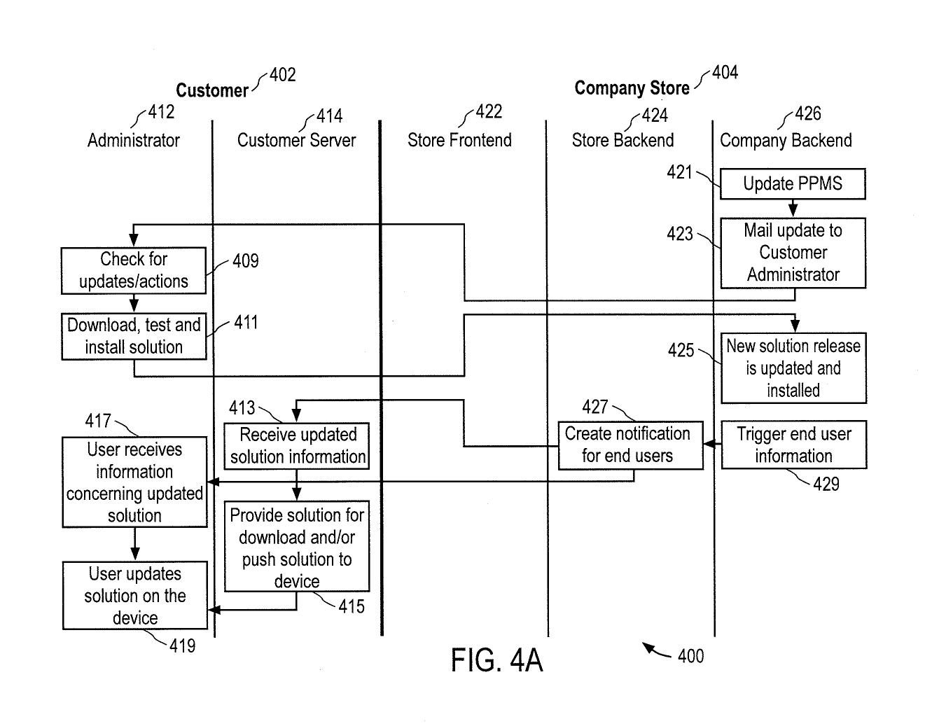

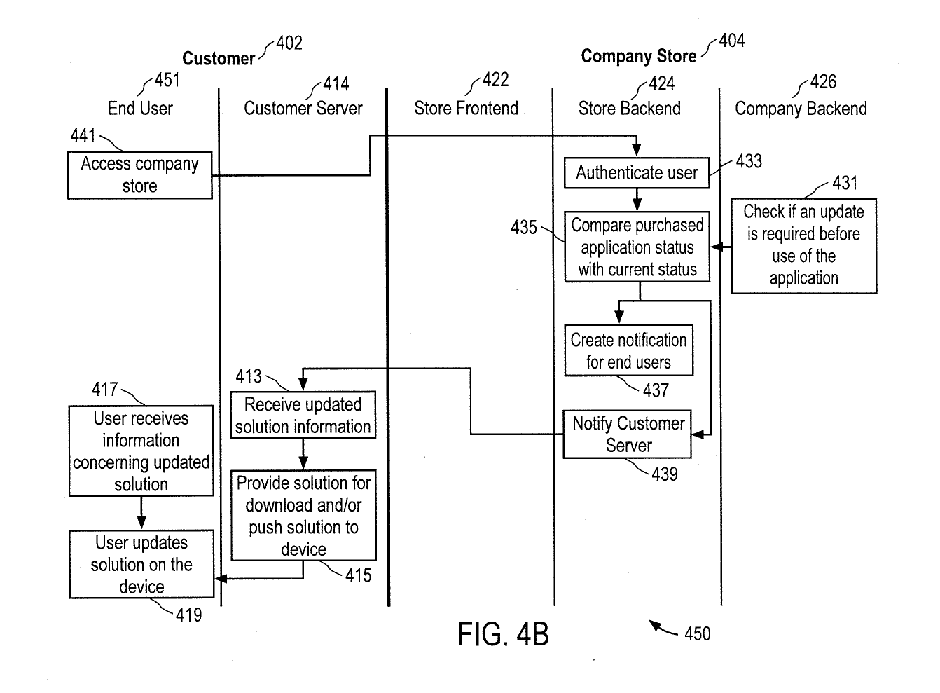

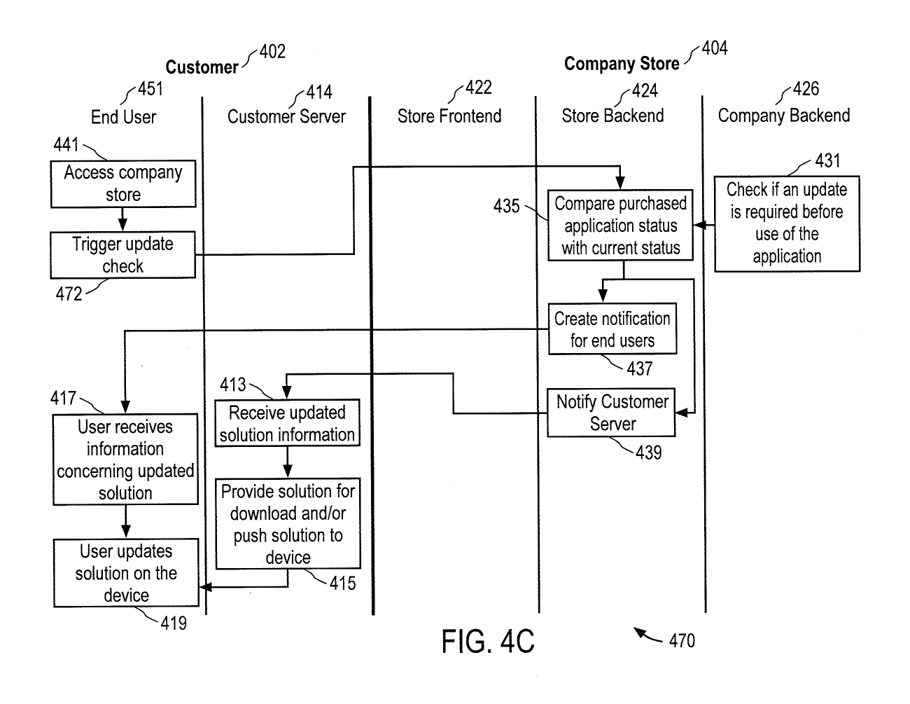

In some implementations, the customer's store that can exist in conjunction with the company store and can be configured to allow lifecycle management for various mobile applications that can be offered through the customer's catalog. Lifecycle management can include updating of purchased solutions/applications, adding/removing applications, adding/removal of users of applications and/or mobile devices, as well as other functionalities. FIGS. 4a-c illustrate various lifecycle management scenarios that deal with managing a mobile application. FIG. 4a illustrates an administrator's perspective of dealing with an application update; FIG. 4b illustrates updating a lightweight version of the mobile application; and FIG. 4c illustrates updating a full application.

Referring to FIG. 4a, the system 400 includes a customer 402 (which can be a customer store) and a company store 404. In some implementations, the company store 404 can be SAP Store available from SAP AG, Waldorf, Germany. The customer 402 can be configured to communicate with the company store 404. The customer 402 can be configured to include an administrator 412 and a customer server 414. The company store 404 can be configured to include a store frontend 422, a store backend 424, and a company backend 426. Upon receiving an update to the business solution/application that may be available from the company store, at 421, the company backend can be configured to notify an administrator of the update to the business solution/application, at 423. Notification of an update to a particular business solution/application can be received using product and production management system (“PPMS”) identification information relating the particular business solution/application. An exemplary PPMS is available from SAP AG, Waldorf, Germany.

Upon receiving information concerning an update information from company backend, the customer's administrator 412 can be configured to check for updates/actions that may need to be performed to update a particular business solution/application, at 409. If needed, the update (e.g., a new release of the business solution/application, an update to a component of the business solution/application, etc.) can be downloaded, tested, and/or installed, at 411. After installation, the company backend can be appropriately notified and information about the update to the business solution/application or a new solution can be installed at the company backend, at 425. An end user information update can also be triggered at the company backend, at 429. Then, a notification of the update can be created for end users at the company store backend, upon receiving a trigger from the company backend, at 427. The information about the update is then received at the customer server 414, at 413, and the updated (or newly released solution) can be prepared for download and push to the user(s)' mobile devices, at 415. The user(s) can receive a notification of an update or a new solution, at 417, and initiate an update to the mobile device, at 419.

FIG. 4B illustrates an exemplary system 450 for installation and/or updating of a lightweight mobile application, according to some implementations of the current subject matter. System 450 can have similar components to and is configured to perform some of the similar operations as the system 400 shown in FIG. 4A. To install and/or update a business solution/application on the user's mobile device, the end user 451 can access the company store, at 441. Store backend 424 can be configured to authenticate the user, at 433. This can be done by authenticating user's credentials, user's mobile device, as well as the business solution/application that has been purchased/updated. Once the user is authenticated, the status of the purchased business solution/application can be compared to the existing status of that business solution/application, at 435. A report can be generated to indicate the comparison of the statuses and whether or not an update is required based on a check performed by the company backend, at 431. Based on the comparison, a notification can be created for the end users, at 437, as well as the customer's server 414, at 439. The notifications can be forwarded to the end users and the servers, as discussed above with regard to FIG. 4A.

FIG. 4C illustrates an exemplary system 470 for updating a mobile application on the end user's mobile device, according to some implementations of the current subject matter. This scenario is similar to the scenario shown in FIG. 4B, except that upon end user's 451 login to the customer's store, a business solution/application in the customer's store can be configured to trigger an update check, at 472, and can be configured to forward that the company store's backend for comparing the business solution/application new status with its current status to determine whether or not an update is required, at 435.

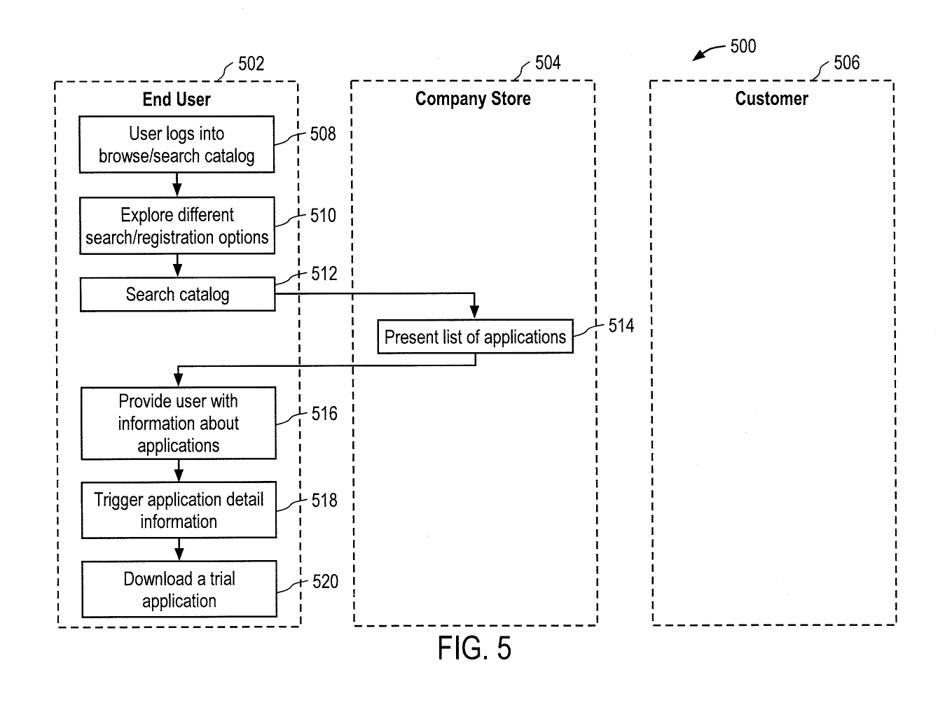

The following discussion along with FIGS. 5-9 illustrates company store scenarios dealing with various options that can be available to end users. FIG. 5 illustrates a system 500 for allowing an end user to access a company store and search for various business solutions/application, according to some implementations of the current subject matter. The system 500 includes an end user 502, a company store 504, and a customer 506. The end user 502 can be configured to access the company store 504, at 508, for the purposes of browsing/searching for a particular business solution/application that may be available for purchase/free trial by the company. The user can be given various options, at 510, including registration with the company store, different ways of searching the company catalog, access to external information sources, and various other options. At 512, the user can be configured to search the catalog to locate various business solutions/applications that may suit user's needs. The user can search using at least one the following criteria or attributes: solution/application operating system (“OS”) type, OS operating versions, solution/application type, user's industry, user's business areas, language of the solution/application, most popular solutions/applications, rating of solutions/applications, new solutions/applications, pricing of the solutions/applications, topics (e.g., “analytics”, “sales”, etc.), user's role in his/her company, and/or any other criteria, and/or any combination thereof.

The user can also use a variety of filters to narrow down his/her search for business solutions/applications. For example, the user can filter a business area, solution type, e.g., solution for a mobile device, device type, etc. In some implementations, filtering of the catalog can be configured to classify solutions/applications based on at least one of the following attributes: solutions/applications OS type (e.g., Blackberry, Apple etc.), OS version of the device (e.g., Apple iOS 4.3), solutions/applications type (e.g., mobile solutions/applications, etc.), language of the solutions/applications, solutions/applications family (e.g., a combination of multiple solutions/applications into one “product” but with different OS/device types), solutions/applications release status (e.g., released, in test, etc.), solutions/applications store visibility, solutions/applications location (e.g., local download from company store/company backend, a third party store, etc.), solutions/applications cost range (e.g., free, $0.01-$10, more than $10), solutions/applications type (e.g., native solutions/applications connected directly to backend, player solutions/applications which can require a backend user, a web app, etc.), latest version of the solution/application, a specific version of the solution/application as an additional attribute, requirement of an installation (e.g., solutions/applications only, backend components necessary, user license necessary, etc.), as well as any other attributes and/or a combination thereof.

After completion of the search, the company 504 can be configured to present the user with a list of resulting solutions/applications, at 514. At 516, the user can be provided with information about the resulting solutions/applications, at 518. The information can include at least one of the following: name of the solution/application, short description of the solution/application, ratings of the solution/application, which device the solution/application is configured for, price, solution/application's screenshots, technical information/requirements of the solution/application, a further details button for the solution/application, a number of available downloads for the solution/application, an option to evaluate the solution/application after registration and download, an option to directly buy the app, as well as any other information about the solution/application.

At 520, the user 502 can be configured to request download of the trial version of a particular solution/application.

In some implementations, the user upon accessing the company store can be configured to provide information about the device(s) that the user is using or has, so that the user's company store experiences can be appropriately tailored, including, for example, showing only those solutions/applications that the user can use and/or install on his/her device(s).

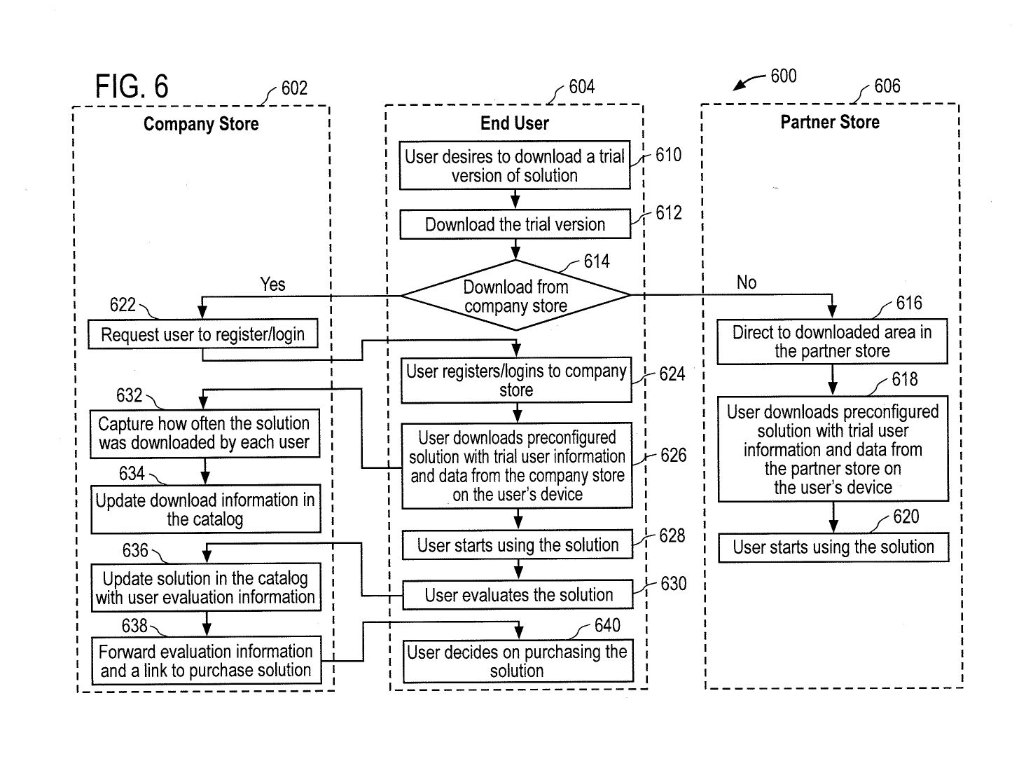

FIG. 6 illustrates an exemplary process 600 for obtaining a trial version of a solution/application for the user's device, according to some implementations of the current subject matter. After selecting a particular solution/application (as shown in FIG. 5), the user 604 may wish to download that solution/application from the product catalog of a company store 602, at 610. At a user interface on the user's device, the user can be configured to push a “download” button for the purposes of downloading that solution/application, at 612. At 614, a determination is made whether or not the solution/application will be downloaded from the company store. If not, then a link in the catalog can be provided to the user directing the user to a download area in a store of a partner company 606, at 616. At 618, the user downloads the solution/application from the partner company's store and starts using the application, at 620.

If the solution/application is to be downloaded from the company store 602, the user can be asked to register and/or login to the company store, at 622. Upon registering/logging in, at 624, the user can download the solution/application to his/her device, where the solution/application can be preconfigured with a trial user and data information from the company store, at 626. The user can start using the downloaded trial version of the solution/application, at 628, and can evaluate the trial version, at 630. User evaluation information can be sent to the company store 602 and catalog information can be updated with the user evaluation information, at 636. At 638, the company store can provide a notification to the user concerning evaluation as well as a link requesting the user to buy the solution/application, at 638. At 640, the user can make a decision whether or not to buy the solution/application.

Upon downloading the solution/application, the company store 602 can be configured to collect information about how often the solution/application was downloaded by each particular user, at 632, update download information for that particular solution/application and appropriately update data corresponding to the solution/application in the company store catalog, at 634.

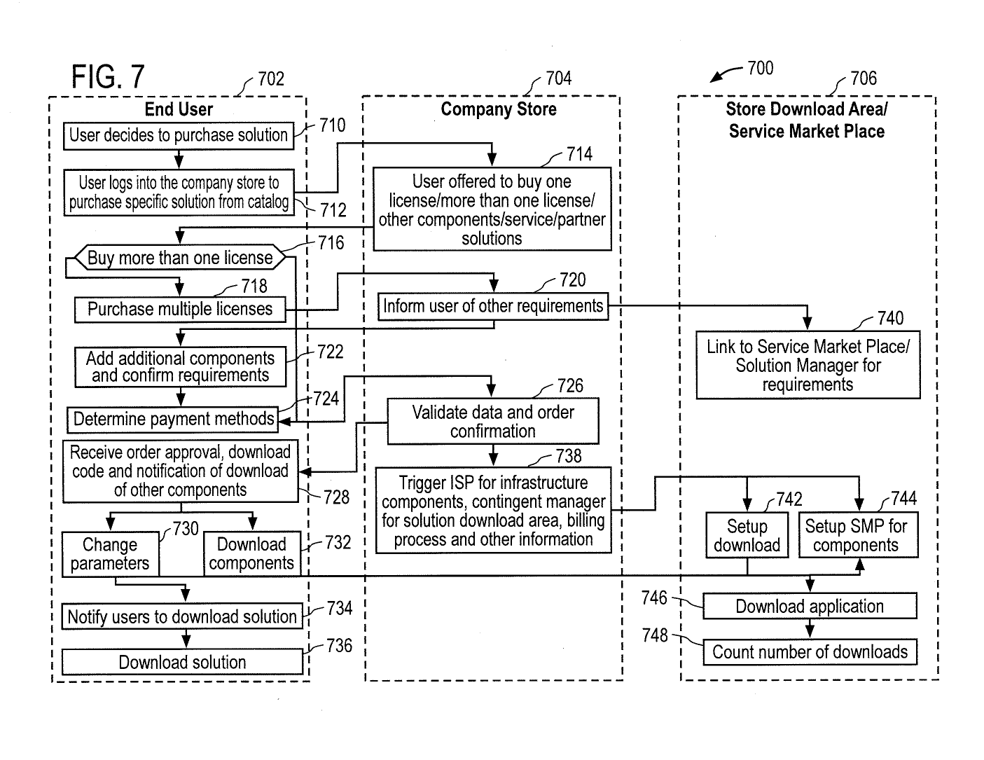

FIG. 7 illustrates an exemplary process 700 for purchasing a solution/application, according to some implementations of the current subject matter. At 710-714, after login, the user can click on a button to buy a solution/application. In some implementations, the user can have an option to buy one solution/application license, multiple licenses, additional infrastructure parts, additional components, and/or any other solutions. If the user buys a partner solution/application, the user can be forwarded to the partner's store to complete the purchasing transaction (not shown in FIG. 7). At 716, the user can determine whether or not the user wishes to purchase more than one license for the selected solution/application (e.g., to be used on multiple devices, and/or by multiple users, etc.). If the user wishes to purchase only a single license for the solution/application, then the user can proceed to complete the purchase transaction and download and install the purchased solution/application on his/her device.

If the user desires to purchase multiple licenses, the user can initiate purchase of more licenses, at 718, and the company store 704 can be configured to inform the user, at 720, whether any additional components, infrastructure components may be needed to accommodate user's request. The company store can provide a link to the company store download area 706 to check for any additional requirements in connection with the user-selected solution/application, at 740. At 722, the user can confirm and/or add any additional components to the user's purchase. At 728, the user can determine user's payment methods and the payment method information can be verified by the company store 704, at 726. Upon receipt of an order approval from the company store as well as notification download of any other components, at 728, the user can change any parameters relating to the solution and begin download of the solution/components, at 730-732. The user can be notified of the solution being downloaded, at 734-736. That information can also be provided to the store download area 706 to provide the user with the necessary downloading.

The company store can also issue confirmation information concerning the purchase. It can also initiate a trigger to any providers (e.g., an ISP) to prepare any infrastructure components, software, applications, etc. that have been selected by the user for download to the user's device(s), at 738. The triggers can be provided to the store's download area/service market place 706. The solution market place 706 can be configured to set up download of the selected application and various additional/other components selected by the user, at 742-744. The solution/application can be downloaded to users device at 746 and a count of the number of downloads is stored, at 748.

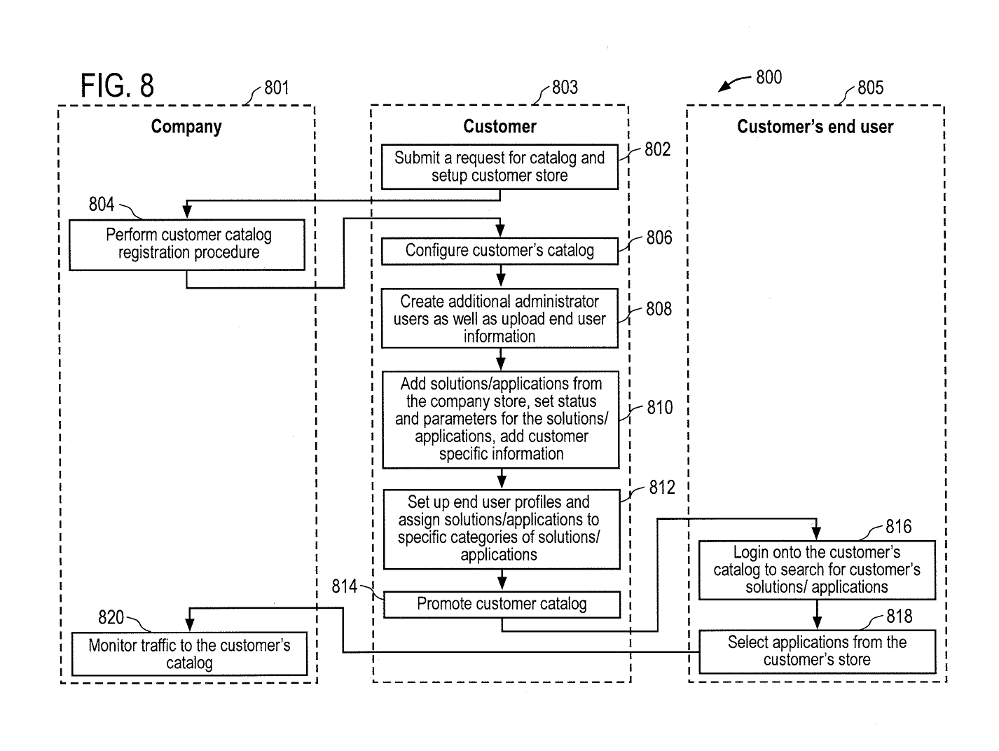

FIG. 8 illustrates an exemplary process 800 for setting up a customer's store, according to some implementations of the current subject matter. At 802, the customer 803 or its administrator can be configured to submit a request to setup a customer store to the company 801. The request can be forwarded to the company 801, where the company performs a customer catalog registration procedures 804 during which the company can be configured to check customer's request against customer's records, perform catalog registration and release the catalog application to the customer for download. Then, the customer 803 can be configured to configure customer's catalog as well as change its look and feel, at 806. At 808, the customer 803 can be configured to create additional administrator users as well as upload end user information. At 810, the customer 803 can be further configured to add further solutions/applications from the company store 801, set status and various parameters for the solutions/applications, add customer-specific information, as well as perform any other functions. At 812, the customer 803 can be configured to set up any end user profiles and assign solutions/applications to specific categories of solutions/applications. At 814, the customer can begin to promote its catalog to its clients and users. Such promotion can be done via email or other forms of communications.

Customer's clients or end users can login onto the customer's catalog to search for customer's solutions/applications, at 816. If customer's clients/end users locate specific applications, they can select such applications from the customer's store, the company store, or third party (e.g., partner) stores which may cater to device-specific needs, at 818. The company 801 can be configured to monitor traffic to the customer's catalog, at 820.

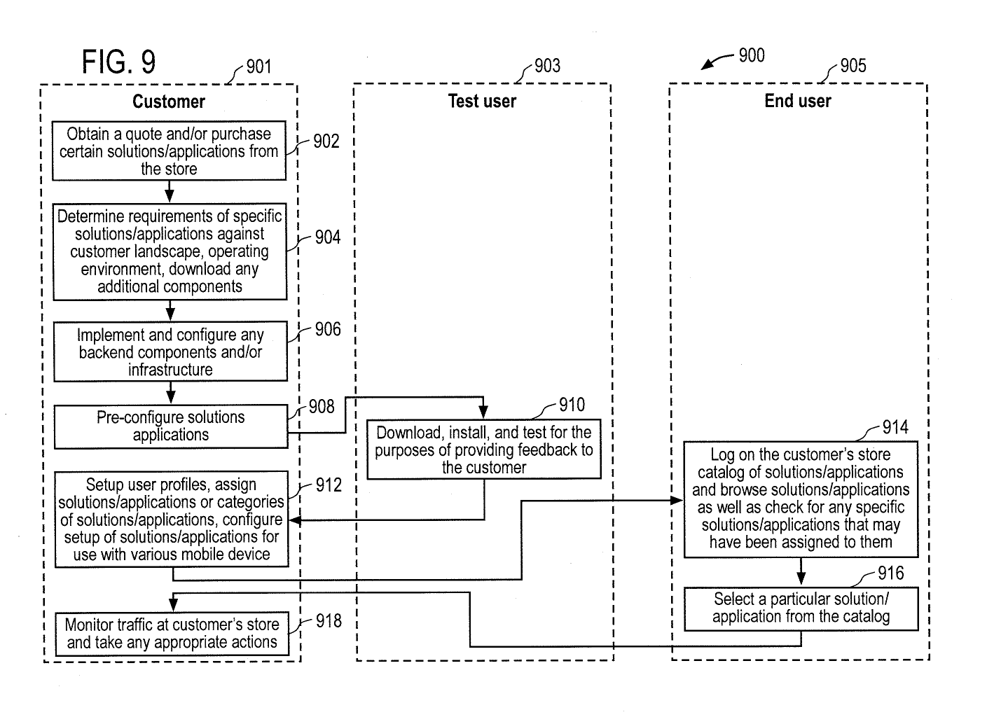

FIG. 9 illustrates an exemplary method 900 for operating a customer store, according to some implementations of the current subject matter. At 902, customer's administrator 901 can be configured to obtain a quote and/or purchase certain solutions/applications from the company store, partner stores (including company's partners and customer's partners) and/or from any third parties. The quotes can include information about purchasing a single license for solutions/applications or multiple licenses for solutions/applications. At 904, the administrator can be also configured to determine requirements of specific solutions/applications against customer landscape and/or operating environment, and/or download any additional components, if necessary. At 906, the administrator can implement and configure any backend components and/or infrastructure that may be required to support the solutions/applications. The administrator can also pre-configure solutions/applications with customer's logo, specific information, requirements, settings, etc., at 908. The administrator can also assign specific solutions/applications to test users 903 for downloading, installation, and testing for the purposes of providing feedback to the customer, at 910. Upon receiving feedback from the test users 903, the customer's administrator 901 can be configured to setup user profiles, assign solutions/applications or categories of solutions/applications, configure setup of solutions/applications for use with various mobile devices, at 912.

At 914, end users 905 of the customer 901 can be configured to log on to the customer's store catalog of solutions/applications and browse solutions/applications as well as check for any specific solutions/applications that may have been assigned to them for use (e.g., assignment can be performed based on the end user's needs, requirements, mobile devices, etc.). The browsing can be performed using an internet browser, a store application pre-loaded on the end user's mobile device, and/or using any other means. Once the end user 905 selects a particular solution/application from the catalog, the end user can download the solution/application from the company store, customer's store, partner stores (including company's partners and customer's partners) and/or from any third parties, at 916. The customer's administrator can be configured to monitor traffic at customer's store and take any appropriate actions (e.g., require end user to purchase of additional licenses, suspend licenses of end user, provide additional incentives or discounts to the end user, etc.)

In some implementations, the end user can be configured to download a company store application to enhance user's searches for solutions/applications. The user can download such application to his/her mobile device by entering the company store on the device. The user can also download similar store application on the user's stationary computing devices. The company store can be configured to recognize user's device types automatically so that an appropriate version of the store application is provided to the user. Once downloaded, the store application can be installed to allow the user to perform searching, filtering, selecting, downloading, installing, etc. of solutions/applications listed in the catalog. In some implementations, the user's filtering requirements can be automatically recognized by the company store based on the user's identification information, user's device(s), as well as any other parameters. This way, the user's experiences at the company store is optimized for the user's needs.

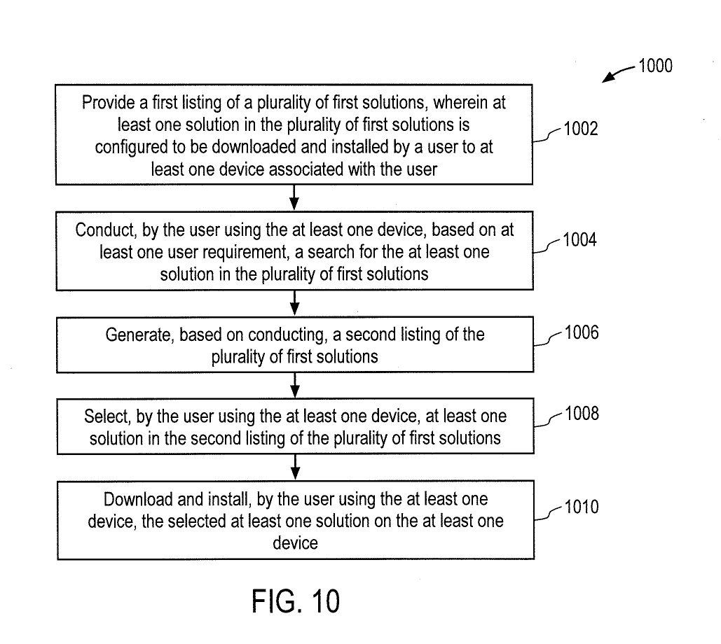

FIG. 10 illustrates an exemplary method 1000 for providing a company store, according to some implementations of the current subject matter. At 1002, a first listing of a plurality of first solutions can be provided, wherein at least one solution in the plurality of first solutions can be configured to be downloaded and installed by a user to at least one device associated with the user. At 1004, a search for the at least one solution in the plurality of first solutions can be conducted by the user using the at least one device based on at least one user requirement. At 1006, based on conducting, a second listing of the plurality of first solutions can be generated. At 1008, at least one solution in the second listing of the plurality of first solutions can be selected by the user using the at least one device. At 1010, the selected at least one solution on the at least one device can be downloaded and installed by the user using the at least one device. At least one of the providing, the conducting, the generating, the selecting and the downloading and installing can be performed on at least one processor.

In some implementations, the current subject matter can be configured to include at least one of the following optional features. At least one device can be a mobile device. The process 1000 can also include generating a third listing of a plurality of solutions, wherein the third listing is configured to include at least one solution in the plurality of first solutions and associating the generated third listing with a first customer. The process can also include accessing, by the user using the at least one device, the generated third listing associated with the first customer, conducting, by the user using the at least one device, based on at least one user requirement, a search for the at least one solution in the third listing of the plurality of solutions, selecting, by the user using the at least one device, at least one solution from the third listing of the plurality of solutions, and downloading and installing, by the user using the at least one device, the at least one solution selected from the third listing of the plurality of solutions on the at least one device.

At least one user requirement can be configured to include at least one of the following: an identification of user, an identification of solutions that the user is configured to use on the at least one device associated with the user, an identification of the at least one device associated with the user, a number of users configured to use the selected at least one solution after the selected at least one solution is downloaded and installed, and a number of devices associated with the user configured to use the selected at least one solution after the selected at least one solution is downloaded and installed.

The downloading and installing can include requesting payment from the user for the selected at least one solution.

Further, the selected at least one solution can be configured to correspond to a trial version of the selected at least one solution, wherein the trial version is configured to limit use of the selected at least one solution by the user after the downloading and installing. In this case, the process 1000 can also include testing, by the user using the at least one device, the trial version of the selected at least one solution and determining, by the user using the at least one device, whether to purchase a full version of the selected at least one solution, wherein the full version of the selected at least one solution does not limit use of the selected at least one solution by the user after the downloading and installing.

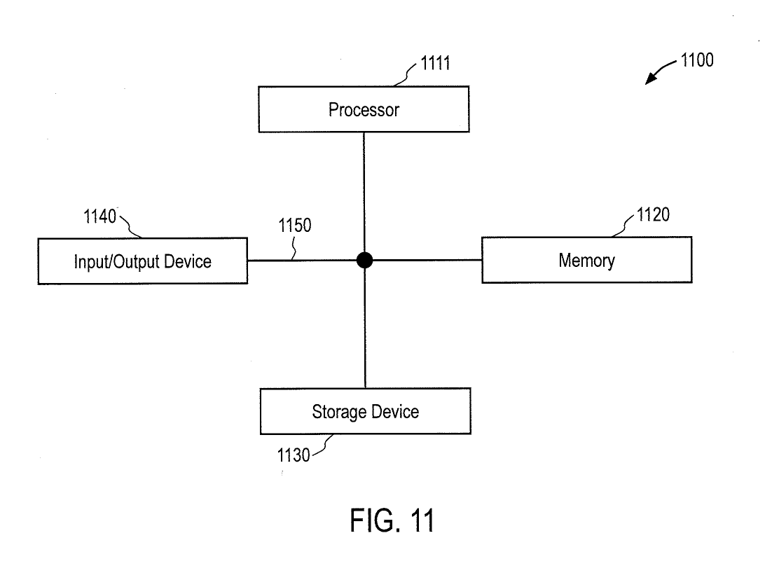

In some implementations, the current subject matter can be configured to be implemented in a system 1100, as shown in FIG. 11. The system 1100 can include a processor 1110, a memory 1120, a storage device 1130, and an input/output device 1140. Each of the components 1110, 1120, 1130 and 1140 can be interconnected using a system bus 1150. The processor 1110 can be configured to process instructions for execution within the system 1100. In some implementations, the processor 1110 can be a single-threaded processor. In alternate implementations, the processor 1110 can be a multi-threaded processor. The processor 1110 can be further configured to process instructions stored in the memory 1120 or on the storage device 1130, including receiving or sending information through the input/output device 1140. The memory 1120 can store information within the system 1100. In some implementations, the memory 1120 can be a computer-readable medium. In alternate implementations, the memory 1120 can be a volatile memory unit. In yet some implementations, the memory 1120 can be a non-volatile memory unit. The storage device 1130 can be capable of providing mass storage for the system 1100. In some implementations, the storage device 1130 can be a computer-readable medium. In alternate implementations, the storage device 1130 can be a floppy disk device, a hard disk device, an optical disk device, a tape device, non-volatile solid state memory, or any other type of storage device. The input/output device 1140 can be configured to provide input/output operations for the system 1100. In some implementations, the input/output device 1140 can include a keyboard and/or pointing device. In alternate implementations, the input/output device 1140 can include a display unit for displaying graphical user interfaces.

The systems and methods disclosed herein can be embodied in various forms including, for example, a data processor, such as a computer that also includes a database, digital electronic circuitry, firmware, software, or in combinations of them. Moreover, the above-noted features and other aspects and principles of the present disclosed implementations can be implemented in various environments. Such environments and related applications can be specially constructed for performing the various processes and operations according to the disclosed implementations or they can include a general-purpose computer or computing platform selectively activated or reconfigured by code to provide the necessary functionality. The processes disclosed herein are not inherently related to any particular computer, network, architecture, environment, or other apparatus, and can be implemented by a suitable combination of hardware, software, and/or firmware. For example, various general-purpose machines can be used with programs written in accordance with teachings of the disclosed implementations, or it can be more convenient to construct a specialized apparatus or system to perform the required methods and techniques.

The systems and methods disclosed herein can be implemented as a computer program product, i.e., a computer program tangibly embodied in an information carrier, e.g., in a machine readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

As used herein, the term “user” can refer to any entity including a person or a computer.

Although ordinal numbers such as first, second, and the like can, in some situations, relate to an order; as used in this document ordinal numbers do not necessarily imply an order. For example, ordinal numbers can be merely used to distinguish one item from another. For example, to distinguish a first event from a second event, but need not imply any chronological ordering or a fixed reference system (such that a first event in one paragraph of the description can be different from a first event in another paragraph of the description).

The foregoing description is intended to illustrate but not to limit the scope of the invention, which is defined by the scope of the appended claims. Other implementations are within the scope of the following claims.

These computer programs, which can also be referred to programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, the subject matter described herein can be implemented on a computer having a display device, such as for example a cathode ray tube (CRT) or a liquid crystal display (LCD) monitor for displaying information to the user and a keyboard and a pointing device, such as for example a mouse or a trackball, by which the user can provide input to the computer. Other kinds of devices can be used to provide for interaction with a user as well. For example, feedback provided to the user can be any form of sensory feedback, such as for example visual feedback, auditory feedback, or tactile feedback; and input from the user can be received in any form, including, but not limited to, acoustic, speech, or tactile input.

The subject matter described herein can be implemented in a computing system that includes a back-end component, such as for example one or more data servers, or that includes a middleware component, such as for example one or more application servers, or that includes a front-end component, such as for example one or more client computers having a graphical user interface or a Web browser through which a user can interact with an implementation of the subject matter described herein, or any combination of such back-end, middleware, or front-end components. The components of the system can be interconnected by any form or medium of digital data communication, such as for example a communication network. Examples of communication networks include, but are not limited to, a local area network (“LAN”), a wide area network (“WAN”), and the Internet.

The computing system can include clients and servers. A client and server are generally, but not exclusively, remote from each other and typically interact through a communication network. The relationship of client and server arises by virtue of computer programs running on the respective computers and having a client-server relationship to each other.

The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and sub-combinations of the disclosed features and/or combinations and sub-combinations of several further features disclosed above. In addition, the logic flows depicted in the accompanying figures and/or described herein do not necessarily require the particular order shown, or sequential order, to achieve desirable results. Other implementations can be within the scope of the following claims.

What is claimed:

1. A computer-implemented method, comprising:
providing a first listing of a plurality of first solutions, wherein at least one solution in the plurality of first solutions is configured to be downloaded and installed by a user to at least one device associated with the user;
conducting, by the user using the at least one device, based on at least one user requirement, a search for the at least one solution in the plurality of first solutions;
generating, based on conducting, a second listing of the plurality of first solutions;
selecting, by the user using the at least one device, at least one solution in the second listing of the plurality of first solutions; and
downloading and installing, by the user using the at least one device, the selected at least one solution on the at least one device;
wherein at least one of the providing, the conducting, the generating, the selecting and the downloading and installing is performed on at least one processor.

2. The method according to claim 1, wherein the at least one device is a mobile device.

3. The method according to claim 1, further comprising
generating a third listing of a plurality of solutions, wherein the third listing is configured to include at least one solution in the plurality of first solutions; and
associating the generated third listing with a first customer.

4. The method according to claim 3, further comprising
accessing, by the user using the at least one device, the generated third listing associated with the first customer;
conducting, by the user using the at least one device, based on at least one user requirement, a search for the at least one solution in the third listing of the plurality of solutions;
selecting, by the user using the at least one device, at least one solution from the third listing of the plurality of solutions; and
downloading and installing, by the user using the at least one device, the at least one solution selected from the third listing of the plurality of solutions on the at least one device.

5. The method according to claim 1, wherein the at least one user requirement is configured to include at least one of the following: an identification of user, an identification of solutions that the user is configured to use on the at least one device associated with the user, an identification of the at least one device associated with the user, a number of users configured to use the selected at least one solution after the selected at least one solution is downloaded and installed, and a number of devices associated with the user configured to use the selected at least one solution after the selected at least one solution is downloaded and installed.

6. The method according to claim 1, wherein the downloading and installing further comprises requesting payment from the user for the selected at least one solution.

7. The method according to claim 1, wherein the selected at least one solution is configured to correspond to a trial version of the selected at least one solution, wherein the trial version is configured to limit use of the selected at least one solution by the user after the downloading and installing.

8. The method according to claim 7, further comprising
testing, by the user using the at least one device, the trial version of the selected at least one solution; and
determining, by the user using the at least one device, whether to purchase a full version of the selected at least one solution, wherein the full version of the selected at least one solution does not limit use of the selected at least one solution by the user after the downloading and installing.

9. A computer program product comprising a machine-readable medium storing instructions that, when executed by at least one programmable processor, cause the at least one programmable processor to perform operations comprising:
providing a first listing of a plurality of first solutions, wherein at least one solution in the plurality of first solutions is configured to be downloaded and installed by a user to at least one device associated with the user;
conducting, by the user using the at least one device, based on at least one user requirement, a search for the at least one solution in the plurality of first solutions;
generating, based on conducting, a second listing of the plurality of first solutions;
selecting, by the user using the at least one device, at least one solution in the second listing of the plurality of first solutions; and
downloading and installing, by the user using the at least one device, the selected at least one solution on the at least one device.

10. The computer program product according to claim 9, wherein the at least one device is a mobile device.

11. The computer program product according to claim 9, wherein the operations further comprise
generating a third listing of a plurality of solutions, wherein the third listing is configured to include at least one solution in the plurality of first solutions; and
associating the generated third listing with a first customer.

12. The computer program product according to claim 11, wherein the operations further comprise
accessing, by the user using the at least one device, the generated third listing associated with the first customer;
conducting, by the user using the at least one device, based on at least one user requirement, a search for the at least one solution in the third listing of the plurality of solutions;
selecting, by the user using the at least one device, at least one solution from the third listing of the plurality of solutions; and
downloading and installing, by the user using the at least one device, the at least one solution selected from the third listing of the plurality of solutions on the at least one device.

13. The computer program product according to claim 9, wherein the at least one user requirement is configured to include at least one of the following: an identification of user, an identification of solutions that the user is configured to use on the at least one device associated with the user, an identification of the at least one device associated with the user, a number of users configured to use the selected at least one solution after the selected at least one solution is downloaded and installed, and a number of devices associated with the user configured to use the selected at least one solution after the selected at least one solution is downloaded and installed.

14. The computer program product according to claim 9, wherein the downloading and installing further comprises requesting payment from the user for the selected at least one solution.

15. The computer program product according to claim 9, wherein the selected at least one solution is configured to correspond to a trial version of the selected at least one solution, wherein the trial version is configured to limit use of the selected at least one solution by the user after the downloading and installing.

16. The computer program product according to claim 15, wherein the operations further comprise
testing, by the user using the at least one device, the trial version of the selected at least one solution; and
determining, by the user using the at least one device, whether to purchase a full version of the selected at least one solution, wherein the full version of the selected at least one solution does not limit use of the selected at least one solution by the user after the downloading and installing.

17. A system comprising:
at least one programmable processor; and
a machine-readable medium storing instructions that, when executed by the at least one programmable processor, cause the at least one programmable processor to perform operations comprising:
providing a first listing of a plurality of first solutions, wherein at least one solution in the plurality of first solutions is configured to be downloaded and installed by a user to at least one device associated with the user;
conducting, by the user using the at least one device, based on at least one user requirement, a search for the at least one solution in the plurality of first solutions;
generating, based on conducting, a second listing of the plurality of first solutions;
selecting, by the user using the at least one device, at least one solution in the second listing of the plurality of first solutions; and
downloading and installing, by the user using the at least one device, the selected at least one solution on the at least one device.

18. The system according to claim 17, wherein the at least one device is a mobile device.

19. The system according to claim 17, wherein the operations further comprise
generating a third listing of a plurality of solutions, wherein the third listing is configured to include at least one solution in the plurality of first solutions; and
associating the generated third listing with a first customer.

20. The system according to claim 19, wherein the operations further comprise
accessing, by the user using the at least one device, the generated third listing associated with the first customer;
conducting, by the user using the at least one device, based on at least one user requirement, a search for the at least one solution in the third listing of the plurality of solutions;
selecting, by the user using the at least one device, at least one solution from the third listing of the plurality of solutions; and
downloading and installing, by the user using the at least one device, the at least one solution selected from the third listing of the plurality of solutions on the at least one device.
